(19) United States
(12) Patent Application Publication
(10) Pub. No.: US 2005/0210109 A1
(43) Pub. Date: Sep. 22, 2005

(54) Load balancing mechanism for publish/subscribe broker messaging system

(75) Inventors: Kyle G. Brown, Apex, NC (US); Robert Woolf, Raleigh, NC (US)

Correspondence Address: A. Bruce Clay;IBM Corporation, T81/503, 3039 Cornwallis Road, RTP, NC, 27709, US

(73) Assignee: International Business Machines Corporation, Armonk, NY (US)

(21) Appl. No.: 10/805,945

(22) Filed: Mar. 22, 2004

(51) Int. Cl. G06F 7/00; G06F 17/30

(52) U.S. Cl. 709/206; 709/217

(57) ABSTRACT

A system and method for load balancing a publish/subscribe messaging system comprising a topic subscription program, a publication program, and a message delivery program is disclosed. The topic subscription program allows a subscriber to subscribe to a topic, and to share a subscription to that topic with other subscribers within the messaging system. The publication program publishes messages to a topic. The message delivery program sends a copy of a message to each subscription and chooses the subscriber within the subscription to receive the message in accordance with a subscription dispatcher. A messaging system which has been configured in accordance with one aspect of the present invention can include a message server; one or more topics stored in the message server; one or more subscriptions associated with at least one of the topics in the message server; and, a subscription program, a publication program and a message delivery program in the server.

### FIELD OF THE INVENTION

The present invention relates to the field of data processing and more specifically to a mechanism for load balancing message consumption across multiple topic subscribers in a publish/subscribe broker messaging system.

### BACKGROUND OF THE INVENTION

Distributed applications have begun to proliferate, as have a host of previously unexplored problems associated with message synchronization, transmission reliability, system scalability, and message security. Present solutions include conventional messaging systems formed from loosely coupled components communicating with one another with asynchronous messages. Notably, conventional messaging systems have been used to build highly reliable, scalable, and flexible distributed applications.

At its core, the conventional messaging system permits separate, uncoupled applications to reliably communicate in an asynchronous manner. Importantly, the messaging system architecture generally replaces the client/server model with a peer-to-peer relationship between individual computing components, wherein each peer computing component can send and receive messages to and from other peer computing components. In consequence, messaging systems can provide several significant advantages over other, more conventional distributed computing models.

For instance, messaging systems encourage “loose coupling” between message consumers and message producers. Specifically, there exists a high degree of anonymity between producer and consumer. In fact, from the perspective of the message consumer, it does not matter who produced the message, where the producer resided in the computing network, and when the message had been produced. As a result, dynamic, reliable, and flexible systems can be assembled whereby entire ensembles of sub-applications can be modified without affecting the remaining portion of the system. In any event, conventional messaging systems assume one of two messaging system models: publish/subscribe and point-to-point.

The publish/subscribe messaging system supports an event driven model where consumers and producers participate in the transmission of messages. A topic represents messages with a common theme. Consumers interested in receiving a theme's messages “subscribe” to the topic. Producers wishing to transmit messages concerning a theme “publish” those messages to the topic. More particularly, producers associate messages with a specific topic, and the messaging system routes messages to consumers based upon the topics for which consumers have registered. When a message is published on a topic, each subscriber receives the message so that every subscriber receives a copy of every message. In point-to-point messaging systems, by comparison, each message is routed to an individual consumer so that even if there are multiple eligible consumers, each message is only consumed by one of the consumers (sometimes referred to as “competing consumers”).

Publish/subscribe broker systems have commonly been integrated into multi-function message broker systems which are used to inter-connect applications which may be on heterogeneous platforms and may use different message formats. For example, Tibco Software Inc. of Palo Alto, Calif. (USA) (www.tibco.com) has such a message broker called “TIB/Message Broker” (both “TIB” and “TIB/Message Broker” are trademarks of Tibco). In these multi-function message brokers, a set of pluggable data processing nodes is provided, with each node being dedicated to a specific data processing task, such as message format transformation, publish/subscribe message distribution, and a dispatcher for deciding (based on a plurality of predefined rules) where an incoming message should be routed.

In these multi-function message broker products, when a subscriber application registers a subscription request with the broker, the subscriber application sends the subscription request to a publish/subscribe broker node specifying the topic of the desired subscription. The publish/subscribe broker node (usually in cooperation with a plurality of other such publish/subscribe broker nodes) then ensures that any published messages on that topic are sent to the subscriber application.

The Java™ Message Service (JMS) API specification, part of the Java 2 Enterprise Edition (J2EE™) platform specification authored by Sun Microsystems of Santa Clara, Calif. (USA), provides standard APIs that Java developers can use to access the common features of enterprise messaging systems. JMS supports both the publish/subscribe and point-to-point models and allows the creation of message types consisting of arbitrary Java objects, arbitrary textural data formats, and arbitrary binary data formats. A fundamental design goal of JMS is to provide a consistent set of interfaces that messaging system clients can use independent of the underlying message system provider. In this way, not only are client applications portable across machine architectures and operating systems, but the client applications also remain portable across messaging products.

Still, in JMS, a messaging system subscriber is single threaded. As a consequence, even when a topic contains multiple messages, a single thread can only process the messages sequentially. Sequential processing limits throughput. For example, given that a topic can have multiple subscribers, and that a Java virtual machine is multithreaded, an application can have multiple subscribers on the same topic with each subscriber running in its own thread. Yet these multiple subscribers do not increase throughput, because the topic simply creates copies of each message for every subscriber. Increasing the number of subscribers increases the number of messages such that no increase in throughput occurs because each subscriber receives each message, and each subscriber must process each message.

What is needed is a system to distribute the work of consuming messages from a message channel (e.g., queues/topics/destinations in WebSphere MQ, Tibco, Microsoft Message Queuing, etc.) across multiple consumers so that the processing effort of the consumers can benefit from load balancing, failover, and other advantages that would be made possible by a distribution across multiple consumers. Multiple consumers dividing up messages on a point-to-point channel (e.g., queue) is not a problem. As discussed above, in a point-to-point messaging system, each message is only consumed by one consumer out of a group of multiple eligible consumers. However, messages cannot be divided up in this manner on a publish/subscribe channel (e.g., topic), because adding more subscribers to a topic only creates more copies of the messages, and each subscriber receives a copy of each message. Thus load cannot be distributed across multiple topic subscribers on a publish/subscribe channel the way it can across multiple queue consumers on a point-to-point channel.

With current messaging system implementations, each topic subscriber gets its own unique subscription. What is needed is an enhanced publish/subscribe messaging system where multiple subscribers can share a single subscription, and a published message would only be delivered to one of the subscribers sharing the subscription. In such an enhanced publish/subscribe messaging system, the messaging system's topic, rather than creating a copy of each published message for every subscriber, would then create a single copy for each subscription. When multiple subscribers share a subscription, a subscription dispatcher would deliver a particular message to only one of the subscribers sharing the subscription. The subscription dispatcher could be configured in a number of ways to achieve load balancing, to provide for failover, and to achieve other advantages.

### SUMMARY OF THE INVENTION

The present invention is a messaging system which overcomes the deficiencies of the prior art and provides a novel and non-obvious system and method for load balancing a publish/subscribe messaging system comprising a topic subscription program, a publication program, and a message delivery program. The topic subscription program allows a subscriber to subscribe to a topic, and to share a subscription to that topic with other subscribers within the subscription. The publication program publishes messages to a topic. The message delivery program sends a copy of a message to each subscription and chooses the subscriber within the subscription to receive the message in accordance with a subscription dispatcher. A messaging system which has been configured in accordance with one aspect of the present invention can include a message server; one or more topics stored in the message server; one or more subscriptions associated with at least one of the topics in the message server; and, a subscription program, a publication program, and a message delivery program in the server.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is an illustration of a computer network used to implement the present invention;

FIG. 2 is an illustration of a computer, including a memory and a processor, associated with the present invention;

FIG. 3 is an illustration of the prior art structure and operation of messaging systems;

FIG. 4 is an illustration of the structure and operation of a messaging system that employs the present invention;

FIG. 5 is a flow chart of the Subscription Program (SP);

FIG. 6 is a flow chart of the Publication Program (PP);

FIG. 7 is a flow chart of the Message Delivery Program (MDP);

FIG. 8A is a diagram of the class structure of the prior art implementation of message delivery; and

FIG. 8B is a diagram of the class structure of the resulting implementation with the present invention.

### DETAILED DESCRIPTION OF THE PREFERRED EMBODIMENTS

As used herein, the term “computer” shall mean a machine having a processor, a memory, and an operating system, capable of interaction with a user or other computer, and shall include without limitation desktop computers, notebook computers, tablet computers, personal digital assistants (PDAs), servers, handheld computers, and similar devices.

As used herein, the term “computer program” shall mean any expression, in any language, code or notation, of a set of instructions intended to cause a system having an information processing capability to perform a particular function either directly or after either or both of the following: (a) conversion to another language, code or notation; (b) reproduction in a different material form.

As used herein, the term “enhanced publish/subscribe message system” shall mean a computer implemented network of publishers and subscribers providing a one-to-many notification system where a message published by a sender is only received by one subscriber within a subscription and the decision as to which subscriber within a subscription is to receive the message is made by a message delivery program that either contains, or has the capability to invoke, a subscription dispatcher.

As used herein, the term “failover” shall mean automatically and transparently redirecting requests from a primary database, server or network to an alternate database, server or network if the primary database, server or network fails or is shut down.

As used herein, the term “load balancing” shall mean distributing the load of processing messages at a subscriber by having a message delivery program distribute the messages for a subscription to the subscribers sharing the subscription, such that any one message for a subscription will only be processed by a single subscriber and the decision as to which subscriber within the subscription will receive a message is made by the message delivery program.

As used herein, the term “message” shall mean precisely formatted data that is produced and consumed by applications and may represent a request, report, or an event.

As used herein, the term “message delivery program” shall mean a program having a subscription dispatcher for determining which subscribers sharing a subscription shall receive a particular message.

As used herein the term “messaging system” shall mean a computer network that provides asynchronous communication between applications that communicate by sending and receiving messages.

As used herein, the term “publish/subscribe message system” shall mean a computer implemented network of publishers and subscribers providing a one-to-many notification system where a message published by a sender is received by all subscribers, where subscribers specify which notifications are of interest by subscribing to a topic for that interest, and where publishers notify interested subscribers by publishing to the topic for that interest.

As used herein, the term “subscription dispatcher” shall mean a software mechanism for deciding which subscriber will receive a message where a plurality of subscribers are sharing a subscription and only one subscriber can receive each message: the software mechanism may vary in complexity from an algorithm providing an arbitrary distribution to a rules engine, and may further comprise a capability to automatically alter the algorithm or the rules engine in response to data received by monitoring subscriber activity.

As used herein, the term “topic” shall mean an intermediate address for messages conforming to a common interest that keeps message publishers independent of subscribers, and vice versa and that automatically adapts to changes in both publishers and subscribers.

As used herein, the term “publisher” shall mean the part of a computer program that sends messages to a topic.

As used herein, the term “subscriber” shall mean the part of a computer program that receives messages from a topic wherein the subscriber expresses interest in a topic by subscribing to it and then has a subscription to the topic so that it will receive messages sent to that topic.

As used herein, the term “subscription” shall mean a record of a subscriber's interest in receiving the messages published on a topic.

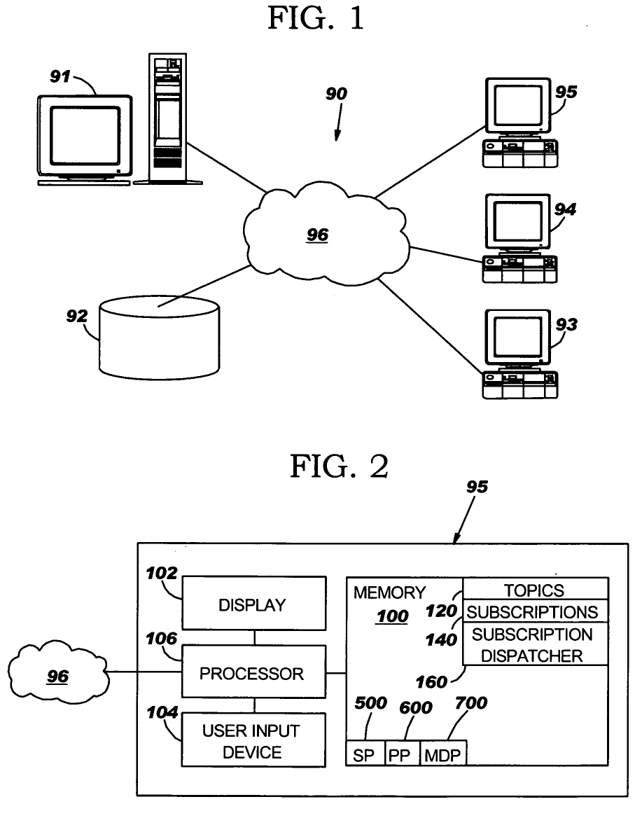

FIG. 1 is an illustration of computer network 90 associated with the present invention. Computer network 90 comprises local computer 95 electrically coupled to network 96. Local computer 95 is electrically coupled to remote computer 94 and remote computer 93 via network 96. Local computer 95 is also electrically coupled to server 91 and database 92 via network 96. Network 96 may be a simplified network connection such as a local area network (LAN) or may be a larger network such as a wide area network (WAN) or the Internet. Furthermore, computer network 90 depicted in FIG. 1 is intended as a representation of a possible operating network containing the present invention and is not meant as an architectural limitation. Notably, the server 91 can be Java message service (JMS) compliant. In that regard, the server 91 can reside in a single process address space. For example, the process address space can be a Java virtual machine (JVM). In consequence, the message system can include a multiplicity of threads of execution, each thread hosting a process for communicating a message between one of the topics in the message server and a message subscriber.

The internal configuration of a computer, including connection and orientation of the processor, memory, and input/output devices, is well known in the art. The present invention is a methodology that can be embodied in a computer program. Referring to FIG. 2, the methodology of the present invention is implemented on software by Subscription Program (SP) 500, Publication Program (PP) 600, and Subscription Delivery Program (MDP) 700. SP 500, PP 600, and MDP 700 described herein can be stored within the memory of any computer depicted in FIG. 1. Alternatively, SP 500, PP 600, and MDP 700 can be stored in an external storage device such as a removable disk, a CD-ROM, or a USB storage device. Memory 100 is illustrative of the memory within one of the computers of FIG. 1. Memory 100 also contains topics 120, subscriptions 140, and subscription dispatcher 160. Depending on the complexity of subscription dispatcher 160, it may reside separately as shown, or alternatively may be included within Message Delivery Program 700. The present invention may interface with topics 120, subscriptions 140, and subscription dispatcher 160 through memory 100. As part of the present invention, the memory 100 can be configured with SP 500, PP 600, and MDP 700. Processor 106 can execute the instructions contained in SP 500, PP 600, and MDP 700. Processor 106 is also able to display data on display 102 and accept user input on user input device 104. Processor 106, user input device 104, display 102, and memory 100 are part of a computer such as local computer 95 in FIG. 1. Processor 106 can communicate with other computers via network 96.

In alternative embodiments, SP 500, PP 600, and MDP 700 can be stored in the memory of other computers. Storing SP 500, PP 600, and MDP 700 in the memory of other computers allows the processor workload to be distributed across a plurality of processors instead of a single processor. Further configurations of SP 500, PP 600, and MDP 700 across various memories are known by persons of ordinary skill in the art. The present invention may be a method, a stand alone computer program, or a plug-in to an existing computer program. For computer programs such as those described herein, persons of ordinary skill in the art are aware of how to configure the programs to plug into an existing computer program.

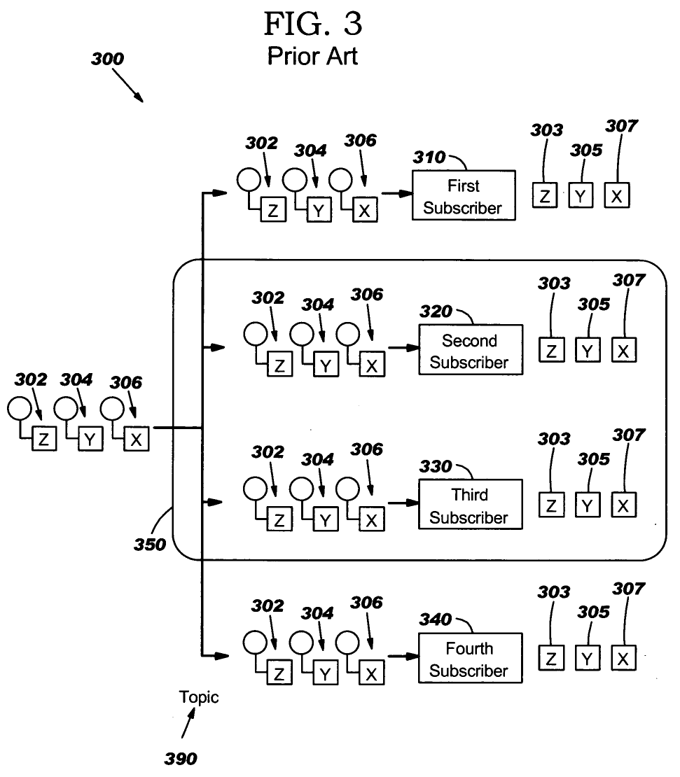

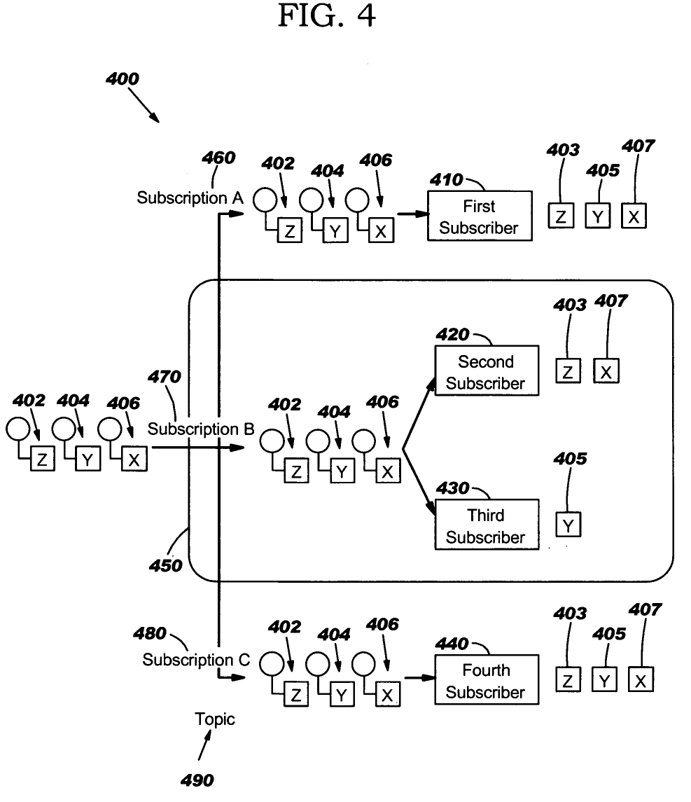

FIG. 3 depicts an illustration of the prior art implementation. The presently known structure and operation of distributing messages in a publish/subscribe messaging system is to send each message to each subscriber. Publish/subscribe system 300 has topic 390, which distributes messages Z 302, Y 304, and X 306 to first subscriber 310, second subscriber 320, third subscriber 330 and fourth subscriber 340. Messages Z 302, Y 304 and X 306 have a header (shown by a circle) and data (shown by a square box). Each subscriber receives messages Z 302, Y 304 and X 306 delivering data Z 303, Y 305, and X 307, in accordance with the prior art topic distribution system. Area 350 is designated for comparison with the enhanced publish/subscribe messaging system of FIG. 4 and is not intended to denote any functional feature or limitation.

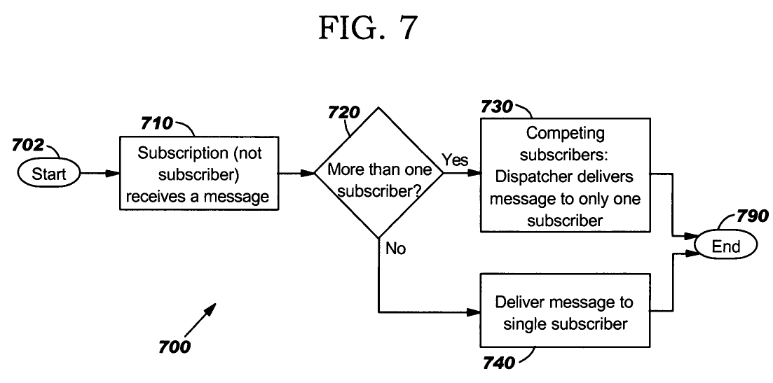

FIG. 4 depicts an illustration of enhanced publish/subscribe messaging system 400. Messages Z 402, Y 404 and X 406 are to be distributed as in FIG. 3. As in FIG. 3, Messages Z 402, Y 404 and X 406 have a header (shown by a circle) and data (shown by a square box). In enhanced publish/subscribe messaging system 400, the messages are delivered by subscription. First subscriber 410 has subscription A 460. Second subscriber 420 and third subscriber 430 share subscription B 470. Fourth subscriber 440 has subscription C 480. First subscriber 410 receives message Z 402, Y 404 and X 406 (delivering data Z 403, Y 405 and X 407) because it has its own subscription, subscription A 460. Likewise, fourth subscriber 440 is the only subscriber of subscription C 480, and so receives messages Z 402, Y 404 and X 406 (delivering data Z 403, Y 405 and X 407). Area 450 is designated for comparison with the prior art publish/subscribe messaging system of FIG. 3 and is not intended to denote any functional feature or limitation. Referring to area 450, it is shown that second subscriber 420 and third subscriber 430 share subscription B 470. A decision as to which messages go to which subscriber will be made by a Message Delivery Program (see FIG. 7). Subscription B 470, as a topic subscription, receives messages Z 402, Y 404 and X 406, which is the standard delivery for topic based message systems. However, since second subscriber 420 and third subscriber 430 share subscription B 470's set of messages, each message can only go to one of the subscribers. In the example shown in FIG. 4, message Z 402 and X 406 go to second subscriber 420, delivering data Z 403 and data X 407; while message Y 404 goes to third subscriber 430, delivering data Y 405. The distribution of messages X 406, Y 404, and Z 402 is made by a subscription dispatcher within the message delivery program.

The distribution by subscription can be accomplished in a variety of ways. In JMS, a subscriber is created by invoking the method:
TopicSubscriber::TopicSession#createSubscriber(Topic)
   Message distribution by subscription requires a similar method with an extra parameter for specifying a unique subscription ID; a JMS durable subscriber specifies its subscription using a string, so this feature can as well. In the new method:
TopicSubscriber::TopicSession#createSubscriber(Topic,String)
   the second parameter is a string that uniquely identifies a subscription. When a subscriber wishes to create a new subscription, the creator will call createSubscriber(Topic,String) with a new and unique subscription ID (or simply call createSubscriber(Topic), which will generate its own new and unique subscription ID). When two or more subscribers wish to share a subscription, the creator will call createSubscriber(Topic,String) repeatedly to create the subscribers, but will provide the same subscription ID every time (which itself is unique from all other subscription IDs), thereby causing all of the subscribers to share the same subscription.

When a message is published on a topic, the messaging system normally creates a copy for each subscriber. Now, the messaging system will create a copy for each subscription. If a subscription has multiple subscribers, only one subscriber will receive each message, and the decision as to which subscriber receives which message made will be made by the subscription dispatcher in the message delivery program. A subscriber can still ensure that it receives a copy of every message published by ensuring that it is the only subscriber on its subscription, which it can do by making sure its subscription ID is secret, or perhaps by specifying to the topic that its subscription cannot be shared with other subscribers.

Both durable and nondurable subscribers can share a subscription. If a subscription has all nondurable subscribers, the subscription survives as long as any of them remain connected; when they all disconnect, the subscription ends. If a subscription has at least one durable subscriber, the subscription does not end until all of the durable subscribers unsubscribe and all of the nondurable subscribers disconnect.

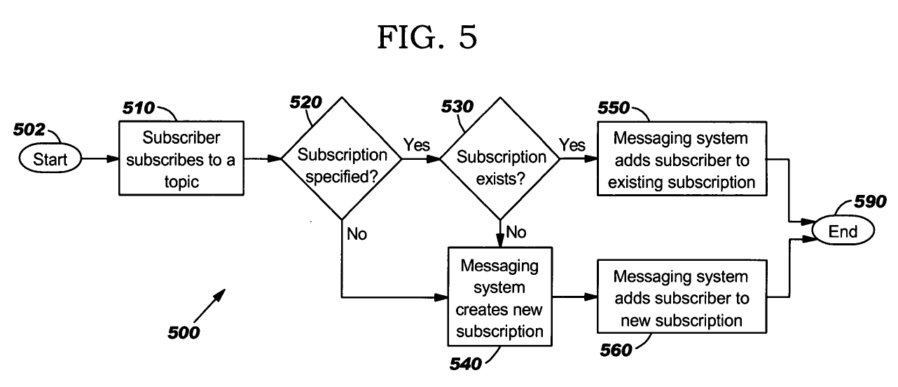

FIG. 5 depicts a flow chart of subscription program (SP) 500. SP 500 starts (502) and a Subscriber subscribes to a topic (510). A determination is made whether the subscription is specified (520). If not, SP 500 goes to step 540. If so, a determination is made as to whether the subscription exists (530). If so, SP 500 goes to step 550. If not, SP 500 goes to step 540. At step 540 the messaging system creates a new subscription (540), adds the subscriber to the new subscription (560) and ends (590). At step 550 the messaging system adds the subscriber to the existing subscription (550) and ends (590).

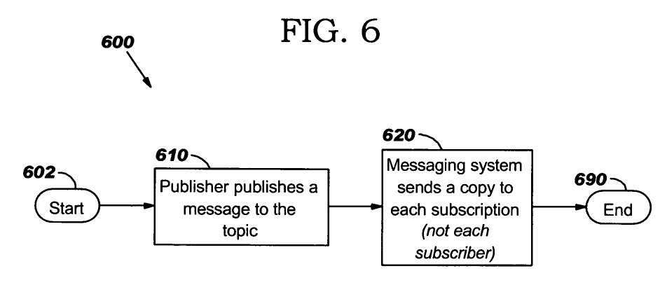

FIG. 6 depicts a flow chart of publication program (PP) 600. PP 600 starts (602) and the publisher publishes a message to the topic (610). The messaging system sends a copy to each subscription (620) and ends (690).

FIG. 7 depicts a flow chart of message delivery program (MDP) 700. MDP 700 starts (702) and the subscription receives a message (710). A determination is made as to whether there is more than one subscriber (720). If so, the message is delivered to only one subscriber selected by a subscription dispatcher (730) and MDP 700 ends (790). If not, the message is delivered to the single subscriber (740) and MDP 700 ends (790).

Persons skilled in the art are aware of numerous ways in which to make decisions regarding which subscriber will receive which message in the enhanced publish/subscribe message system 400. The subscription dispatcher may be included within the Message Delivery Program, or it can reside separately where it can be invoked by the Message Delivery Program. The subscription dispatcher can be as simple as an algorithm or as complex as a rules engine. An algorithm can merely dispatch messages in an arbitrary fashion or it may be more complex. A rules engine may vary in complexity depending on the needs of the designer. The subscription dispatcher enables load balancing to be provided in a system that otherwise would not be able to have such a feature. Even in a very simple form, such as sending one message to the first subscriber, the next message to the next subscriber and so on, the fact that each subscriber now only has to process a portion of the total messages sent from a topic has decreased the processing load for that subscriber. Moreover, the subscription dispatcher may be modified by a system administrator so as to achieve a load balancing distribution in accordance with the needs of that system administrator. Also, the subscription dispatcher can provide failover. For example, if a subscriber's server, network or database fails, the messages will be allocated among the remaining subscribers. Additionally, the subscription dispatcher may be modified by observing behavior aspects of the subscribers within the message distribution system. In other words, a wide variety of load balancing methods are therefore enabled. Since only one message is sent to each subscriber within a subscription, the receiving subscriber only has to process the data from the messages it receives, rather than all of the messages to the topic.

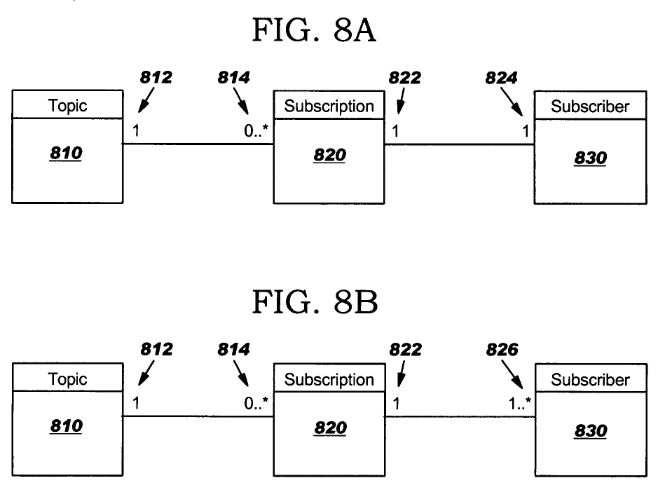

FIG. 8A shows that a topic is associated to a subscriber by a subscription. A topic can have zero or more subscriptions, and a subscription has exactly one subscriber.

FIG. 8B shows the same relationship between topic, subscription, and subscriber, and that a topic can have many subscribers. The change from FIG. 8A is that while in FIG. 8A a subscription can only have one subscriber, FIG. 8B enables multiple subscribers to share a subscription. It is the capability to share a subscription, shown in FIG. 8B, that provides the opportunity for the messaging system to dispatch the subscription's messages across the subscribers, so that the subscribers can consume the subscription's messages concurrently, which can increase message consumption throughput.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Those skilled in the art will appreciate that such computer readable instructions can be written in a number of programming languages for use with many computer architectures or operating systems. Further, such instructions may be stored using any memory technology, present or future, including but not limited to, semiconductor, magnetic, or optical, or transmitted using any communications technology, present or future, including but not limited to optical, infrared, or microwave. It is contemplated that such a computer program product may be distributed as a removable media with accompanying printed or electronic documentation, e.g., shrink wrapped software, pre-loaded with a computer system, e.g., on a system ROM or fixed disk, or distributed from a server or electronic bulletin board over a network, e.g., the Internet or World Wide Web.

Significantly, this invention can be embodied in other specific forms without departing from the spirit or essential attributes thereof, and accordingly, reference should be had to the following claims, rather than to the foregoing specification, as indicating the scope of the invention.

1. An enhanced publish/subscribe messaging system comprising: a message server;
a computer connected to the message server by a network and having a memory containing a subscription program, a publication program, and a message delivery program; a topic in memory of the message server wherein a plurality of subscribers use the subscription program to select a plurality of subscriptions associated with the topic;
wherein, responsive to a publisher publishing a message to the topic, the publishing program sends a copy of the message to each subscription, and the message delivery program sends a single message to each subscriber within a subscription.

2. The enhanced publish/subscribe messaging system of claim 1, wherein the message server is Java™ message service (JMS) compliant.

3. The enhanced publish/subscribe messaging system of claim 1, wherein the message server is a Java™ virtual machine.

4. The enhanced publish/subscribe messaging system of claim 1 wherein the message delivery program further comprises a subscription dispatcher.

5. The enhanced publish/subscribe messaging system of claim 4 wherein the subscription dispatcher further comprises instructions for choosing one subscriber out of a plurality of subscribers sharing a subscription to receive a message wherein such instructions are arbitrary.

6. The enhanced publish/subscribe messaging system of claim 4 wherein the subscription dispatcher further comprises instructions for choosing one subscriber out of a plurality of subscribers sharing a subscription to receive a message wherein such instructions are configurable by a system administrator.

7. The enhanced publish/subscribe messaging system of claim 4 wherein the subscription dispatcher further comprises instructions for choosing one subscriber out of a plurality of subscribers sharing a subscription to receive a message wherein such instructions are generated in response to data received by monitoring subscriber activity within the messaging system.

8. The enhanced publish/subscribe message system of claim 1 wherein the message delivery program includes the capability to automatically and transparently redirect requests from a failed subscriber to another subscriber selected out of the subscribers sharing the subscription; and wherein the failed subscriber is a subscriber having a problem with or shut down of its database, server or network.

9. The enhanced publish/subscribe messaging system of claim 1 wherein the message delivery program further comprises a capability to automatically alter the rules within the subscription dispatcher in response to data received by monitoring the message distribution system.

10. A message system servicing method comprising the steps of:
at a subscriber computer connected to a server computer by a network, subscribing to a topic wherein the subscription is shared with a plurality of other subscribers;
at the server computer, publishing a message to the topic;
receiving the subscription;
sending a message to the subscription; and
delivering the message to a subscriber chosen out of a plurality of subscribers by a message delivery program having a subscription dispatcher.

11. A computer program product, stored on a computer readable storage medium for, when run on a computer system, instructing the computer system to carry out the method of claim 10.

12. A machine readable storage medium having stored thereon a computer program for performing load balancing within message system servicing, said computer program comprising a routine set of instructions for causing the machine to perform the steps of:
receiving a subscription to a topic from a plurality of subscribers;
publishing a message to the topic;
sending the message to the subscription;
delivering the message to a subscriber chosen out of the plurality of subscribers by a message delivery program.

13. An enhanced publish/subscribe message system comprising:
a computer implemented network;
a publisher connected to the network;
a plurality of subscribers connected to the network;
a means for publishing a message to a topic;
a means for the plurality of subscribers to subscribe to the topic;
a means for sending a message to the subscription;
wherein the message is only received by a single selected subscriber within a subscription; and
wherein the decision as to which subscriber is the selected subscriber is made by a message delivery program having a subscription dispatcher.

14. The enhanced publish/subscribe message system of claim 10 wherein the subscription dispatcher is contained within the message delivery program.

15. The enhanced publish/subscribe message system of claim 10 wherein the subscription dispatcher is a separate program that is invoked by the message delivery program.

16. A message delivery system comprising:
a publish/subscribe message system comprising:
a network;
a plurality of publishers connected to the network;
a plurality of subscribers connected to the network;
a first program in the memory of a computer connected to the network wherein the first program provides a one-to-many notification system where a message published by a publisher is received by all of the plurality of subscribers, and wherein each of the plurality of subscribers specify which notifications are of interest by subscribing to a topic for that interest, and where the plurality of publishers notify an interested subscriber by publishing to the topic for that interest;
a second program that modifies the first program to include a subscription program so that each of the plurality of subscribers may select one or more of a plurality of subscriptions associated with the topic; and also to provide a message delivery program that sends a single message to each subscriber within a subscription.
